(19) United States
(12) Patent Application Publication
(10) Pub. No.: US 2020/0347602 A1
(43) Pub. Date: Nov. 5, 2020

(54) STRUCTURE SUPPORT SYSTEM FOR SURFACE OF BUILDING

(71) Applicant: Pipe Pier, Inc., Hamel, MN (US)

(72) Inventors: Patrick A. Hawkins, Plymouth, MN (US); Timothy R. Moncur, Maple Grove, MN (US)

(21) Appl. No.: 16/865,173

(22) Filed: May 1, 2020

Related U.S. Application Data
(60) Provisional application No. 62/842,950, filed on May 3, 2019.

(51) Int. Cl. E04D 13/00; F16M 13/02

(52) U.S. Cl. CPC E04D 13/00; F16M 13/02

(57) ABSTRACT

A support system may separate a structure from a roof of a building. The support system may include a base portion. The base portion may include at least one rounded edge configured to reduce the engagement of the base portion with the structure. A support portion may be coupled to the base portion. The support system may include at least one support channel sized and shaped to receive the structure. The support channel may straddle the structure when the structure is received in the support channel. The base portion may define at least one cutout configured to reduce the amount of drag on the support system, for instance when the support system is exposed to wind.

### CLAIM OF PRIORITY

This patent application claims the benefit of U.S. Provisional Patent Application Ser. No. 62/842,950, entitled “STRUCTURE SUPPORT SYSTEM FOR SURFACE OF BUILDING,” tiled on May 3, 2019 (Attorney Docket No. 558.012PRV), which is hereby incorporated by reference herein in its entirety.

### BACKGROUND

Structures (e.g., pipes, conduit, or the like) are located on top of buildings (e.g., located on a roof of the building). Elongate structures tend to expand and contract with variations in temperature. Longer structures suffer more change of length due to expansion and contraction since the changes aggregate over a long distance. Pipes, conduits, and other structures are supported above the roof of a building so as to prevent the structure's movements from damaging the roofing material of the building. In cases where blocks are used to support the elongate structures, the blocks themselves can move, damaging the roofing material as well.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an isometric view of an example of a support system for separating a structure from a surface of a building according to one embodiment of the present subject matter.

FIG. 2 illustrates a side view of an example of the support system according to one embodiment of the present subject matter.

FIG. 3 illustrates a bottom view of an example of the base portion of the support system according to one embodiment of the present subject matter.

FIG. 4 illustrates another bottom view of an example of the base portion of the support system according to one embodiment of the present subject matter.

FIG. 5 illustrates a perspective view of an adapter bracket.

FIG. 6 illustrates a perspective view of the support system including the adapter bracket of FIG. 5.

FIG. 7 illustrates another perspective view of the support system including the adapter bracket of FIG. 5.

FIG. 8 illustrates a top view of the support system.

### DETAILED DESCRIPTION

The present inventors have recognized benefits of separating structures (e.g., pipes, conduits, vents, drains, or the like) from a surface of a building, for example a roof of the building. Another problem to be solved may include reducing the amount of corrosion the structure experiences. The present inventors have recognized, among other things, that a problem to be solved may include reducing wear or damage to the roof

The present subject matter provides a support system for separating a. structure from a roof of a building. The support system may include a base portion, and the base portion may include a composite material. The base portion may include at least one rounded edge configured to reduce the engagement of the base portion with the structure. The base portion may define at least one through-hole that may be configured to reduce the amount of drag on the support system when the support system is exposed to wind.

The support system may include a support portion coupled to the base portion. The support portion may include the composite material. The support system may include at least one support channel that may be sized and shaped to receive the structure. The support channel may straddle the structure when the structure is received in the support channel.

The base portion may be located between the structure and a surface of a building, for example a roof of the building. Accordingly, the support system may separate the structure from the roof. Separating the structure from the roof may reduce the amount of corrosion the structure experiences when exposed to the elements (e.g., rain, snow, sunlight, or the like). For example, the support system may separate the structure away from moisture, and accordingly inhibit corrosion of the structure due to moisture.

The support system may inhibit wear of the structure or the roof of the building. For example, the structure may expand or contract due to thermal expansion. The expansion or contraction of the structure may cause wear the structure or the roof the building. For example, the movement of the structure may abrade the roof and decrease the lifetime of the roof due to the damage caused by the abrasion. The support structure may inhibit the wearing of the structure or the roof by separating the structure from the roof. The support system 100 may inhibit the wearing of the structure or the roof by allowing the support system 100 to accommodate the movement of the structure without damaging the roof surface.

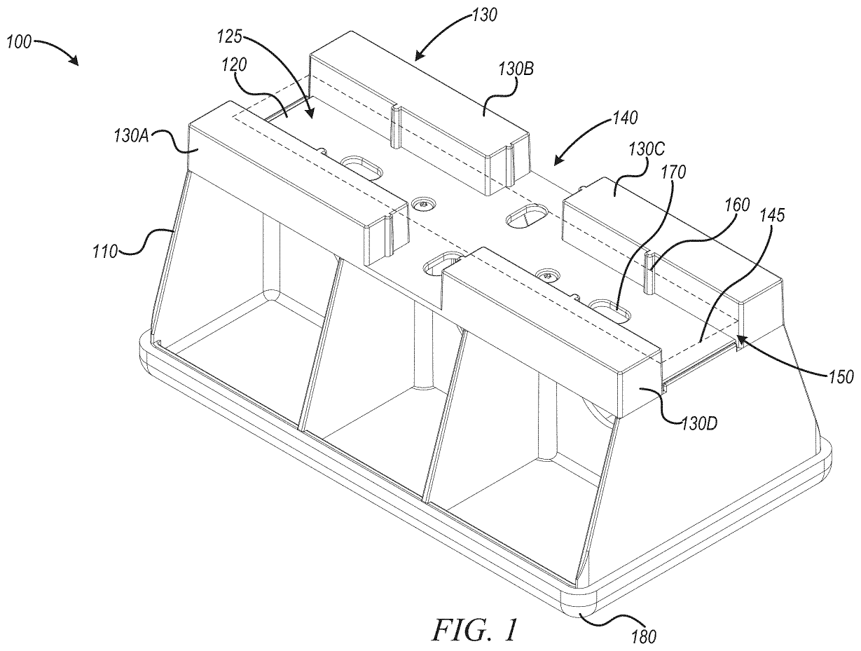

FIG. 1 illustrates an isometric view of an example of a support system 100 for separating a structure from a surface of a building (e.g., a roof) according to one embodiment of the present subject matter. The support system 100 may include a base portion 110. The base portion 110 may distribute the load applied by a structure to the roof by increasing the surface area of the load when the structure is supported by the support system 100.

A support portion 120 may be coupled to the base portion 110. The support portion 120 may be attached and detached from the base portion 110 (e.g., by using a fastener, such as a bolt, to couple the support portion 120 with the base portion 110). The support portion 120 may be configured to support a structure (e.g., a pipe, conduit, vent, drain, or the like). For instance, the support portion 120 may include a support surface 125. The support system 100 may be located between the structure and a surface of a building, and locating the support system 100 between the structure and the surface of the building may separate the structure from the surface.

At least one guide 130 may project from the support surface 125 of the support portion 120. For example, a first guide 130A, a second guide 130B, a third guide 130C, and a fourth guide 130D may project from the support portion 120. The guides 130A-130D may define a first support channel 140 or a second support channel 150. The support channels 140, 150 may be configured to receive the structure, and the support channels 140, 150 may straddle the structure when the structure is located in the channels 140, 150, For example, the guides 130A, 130D may be located on a first side of the structure when the structure is located in the channel 150. The guides 13013, 130C may be located on a second side of the structure when the structure is located in the channel 150.

The guide 130 may include a composite material, for example a glass-filled nylon material. The guide 130 may include a low durometer material, for instance rubber, thermoplastic elastomer, or the like. The guide 130 may yield (e.g., deform, conform, embrace, or the like) in response to a force, for instance to allow for the structure to settle upon the guide 130 and allow the guide 130 to evenly support the structure.

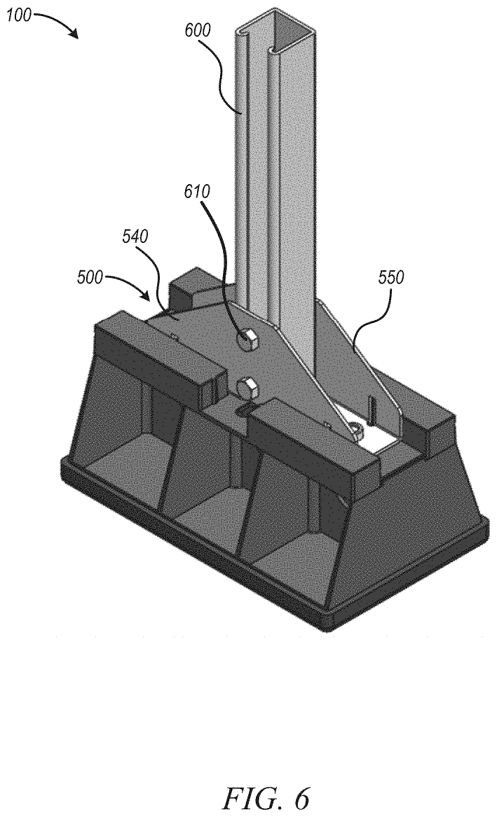

The channels 140, 150 may receive a coupling member 145 (or the coupling member 600, shown in FIG. 6). The coupling member 145 (e.g., a strut, beam, frame, or the like) may facilitate coupling fittings with the support system 100. For example, the coupling member 145 may receive a threaded rod, and the threaded rod may engage with a clamp (e.g., pipe clamps, cable clamps, electrical fittings, saddles, brackets, spring bolts, beam clamps, roller clamps, or the like). The clamp may engage with the structure, and the threaded rod may separate (e.g., elevate) the clamp and the structure with respect to the support system 100. Accordingly, the threaded rod may facilitate height-adjustment of structures supported by the support system 100.

The channel 140 may be offset from the channel 150 (e.g., the channel 140 may extend in a first direction, and the channel 150 may extend in a second direction). For example, the channel 140 may be perpendicular to the channel 1.50. The channel 140 may intersect the channel 150, however the present subject matter is not so limited. For instance, an additional guide 130 may isolate the channel 140 from the channel 150 (e.g., the first channel 140 may not intersect the second channel 150).

The support system 100 may be configured as a modular system with interchangeable components. For instance, the supporting portion 120 may be manufactured in a variety of different configurations (e.g., models, versions, or the like) to facilitate support of various structures depending upon the needs of a user (e.g., pipes having different sizes or diameters). For example, the supporting portion 120 may include one of the channel 140 or the channel 150. The channel 140 and the channel 150 may have varying profiles (e.g., height, width, length, cross-section, or the like). As described herein, the supporting portion 120 may be attached to, and detached from, the base portion 110. Accordingly, the supporting portion 120 with a first configuration (e.g., where the channels 140, 150 intersect) may be interchanged with a different supporting portion 120 having a second configuration (e.g., where the channels 140, 150 do not intersect).

An interference ridge 160 may project from the guide 130, and the ridge 160 may extend into the channel 140 or the channel 150. The interference ridge 160 may provide an interference fit between the guides 130A-130D and the structure when the structure is located in the channels 140, 150. For example, the ridge 160 may engage with an exterior surface of the structure and increase the friction between the guide 130 and the structure. For instance, the ridge 160 may facilitate holding the structure within the channels 140, 150. The interference ridge 160 may provide an interference fit between the guides 130A-130D and the coupling member. The interference ridge 160 may extend to the support surface 125.

At least one mounting hole 170 may extend through the support portion 120. For instance, the mounting hole 170 may extend through the support surface 125 of the support portion 120. The mounting hole 170 may facilitate securing the structure, or the coupling member, to the support system 100. For example, a securing member (e.g., a wire, clamp, fastener, or the like) may be inserted into the mounting hole 170 and the securing member may engage with the structure to retain the structure within the channels 140, 150, The securing member may reduce the translation (e.g., movement, such as sliding, or the like) of the structure relative to support system WO. The securing member may attach the coupling member to the support system 100.

The base portion 110 may rest upon the surface of a building (e.g., a roof). In various embodiments, the roof of the building includes a membrane that seals the roof and inhibits the intrusion of water into the interior of the building. The membrane may be punctured (e.g., by debris, such as metal, screws, or the like), and the punctured membrane may allow water to intrude into the interior of the building. The support system 100 may include a rounded edge 180 to reduce the likelihood of the support system 100 damaging the roof of the building. For instance, the structure may apply a force to the support system 100 and push the support system 100 into the roof. The rounded edge 180 may reduce the likelihood that the force applied by the structure may cause the support system 100 to damage the roof

As described herein, the support system 100 may support a structure (e.g., a pipe transmitting natural gas to an air handler located on a roof of a building). The structure may expand or contract due to variations in temperature (e.g., due to thermal expansion). The expansion and contraction of the structure may correspondingly cause the support system 100 to move. The movement of the support system 100 may wear (e.g., abrade) the roof of the building, and may damage the roof. The rounded edge 180 may reduce the wear upon the roof by the support system 100.

The support system may include a composite material, for instance a glass-filled nylon material, alloy, or the like. For example, the base portion 110 and the support portion 12.0 may include the composite material. The composite material may reduce the overall weight of the support system 100 while providing sufficient mechanical strength to support the structure.

The support system 100 may include one or more base portions 110, and one or more supporting portions 120. For example, the base portions 110 may be arranged end to end to provide additional support for the structure. The base portions 110 may be arranged side by side to support a heavier load. The base portions 110 may support equipment (e.g., an air handler, or the like) to provide a frame for the equipment (e.g., the support system 100 may be located at four corners of a piece of equipment).

The support system 100 may allow the structure to be installed in a level configuration when the surface of the building is not level (e.g., the roof has a pitch, for instance a pitch toward a drain). The support system 100 may allow the structure to be installed in a level configuration if a first portion of the building is offset from a second portion of the building (e.g., if the roof has two sections with varying heights). The support system 100 may allow the structure to be installed in a tilted configuration (e.g., where the structure is not level).

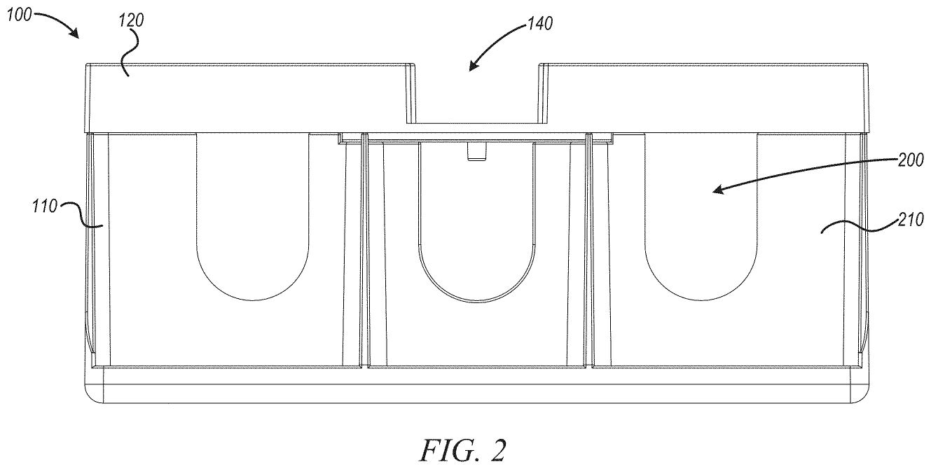

FIG. 2 illustrates a side view of an example of the support system 100 according to one embodiment of the present subject matter. A cutout 200 may be defined in the base portion 110, for instance a structural rib 210 of the base portion 110 may define the cutout 200. The cutout 200 may reduce the amount of drag the support system 100 experiences when the support system 100 is exposed to wind. The cutout 200 may allow air to pass through the base portion 110 and accordingly may reduce the drag on the support system caused by the wind. The cutout 200 may extend parallel to the channel 140, however the present subject matter is not so limited.

The cutout 200 may allow for a structure (e.g., a piece of solid electrical conduit) to pass through the base portion 110. For example, the support portion 120 may be separated from the base portion 110, and separating the support portion 120 from the base portion 110 may allow access to the cutout 200. The structure may be located in the cutout 200, and the support portion 120 may be coupled to the base portion, for instance to secure the structure within the cutout 200.

In various embodiments, the present subject matter provides a support system that is light, strong, resistant to sun exposure, capable of withstanding high temperature variations, and highly configurable for a variety of support applications. The use of materials, such as glass-filled nylon, for one or more portions of the base provides a design that is light and easy to fabricate and assemble, yet strong and long lasting. The design may accommodate a variety of pipe clamps and stand offs, including but not limited to conventional pipe clamps and pipe supporting devices.

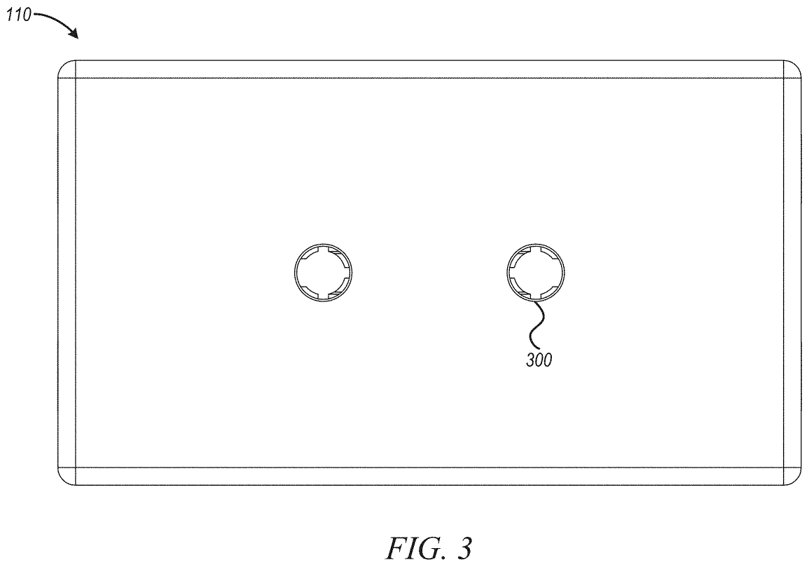

FIG. 3 illustrates a bottom view of an example of the base portion 110 of the support system 100 according to one embodiment of the present subject matter. A drain hole 30( )may extend through the base portion 110 (e.g., a bottom surface of the base portion 110). The drain hole 300 may facilitate drainage of a liquid (e.g., water, condensation, or the like) from the base portion 110 or the support portion 120. For example, the drain hole 300 may allow water to drain from interior portions of the base portion 110.

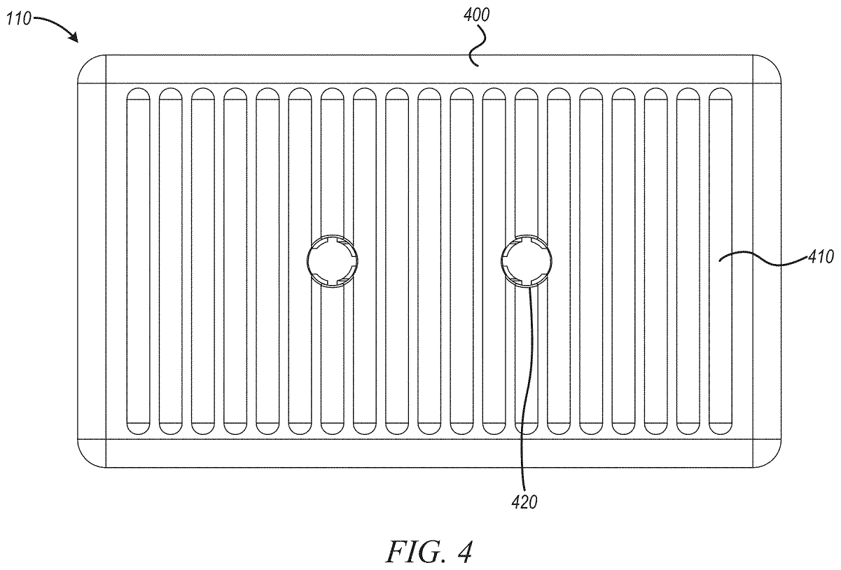

FIG. 4 illustrates another bottom view of an example of the base portion 110 of the support system 100 according to one embodiment of the present subject matter. A boot 400 may be attached to (or detached from) the support system 100. The boot 400 may enhance the friction between the roof and the support system 100. For example, the boot 400 may be attached to the base portion 110 and the boot 400 may help inhibit the movement of the support system 100 (e.g., when a force is applied to the support system 100, for example when wind interacts with the support system 100). The boot 400 may help inhibit the movement of the support system 100 if a light load is applied to the support system 100. The boot 400 may provide vibration isolation to the structure that is supported by the support system 100. The boot 400 may include rubber, a thermoplastic elastomer, or the like. The boot 400 may have a low durometer. The durometer of the boot 400 may be less than the durometer of the base portion 110.

The boot 400 may include one or more feet 410. The feet 410 may increase the traction of the boot 400. The feet 410 may allow water to drain away from the base portion 110. For example, a boot drain hole 420 may extend through the boot 400. Water located in the base portion 110 (e.g., water that drained through the mounting hole 170 of the support portion 120) may be drained from the base portion 110 and flow through the feet 310 and away from the support system 100.

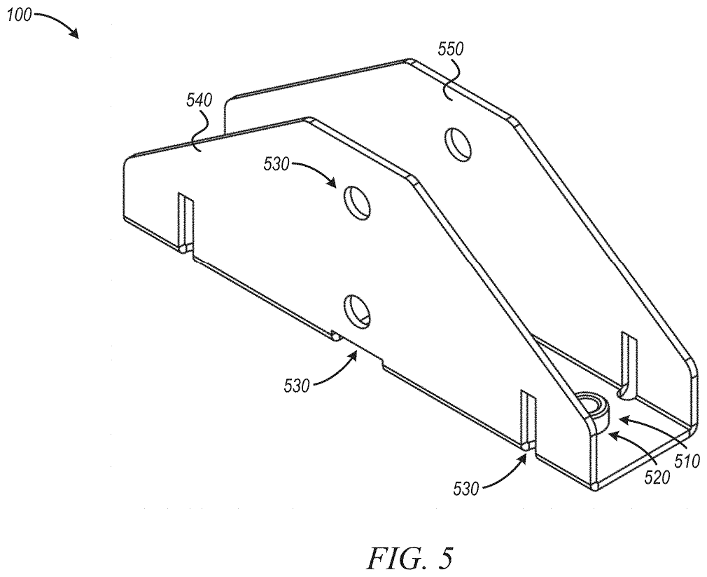

FIG. 5 illustrates a perspective view of an adapter bracket 500. The adapter bracket 500 may couple with the support system 100, for instance with the support portion 120. In an example, the support channel 140 may receive the adapter bracket 500. The adapter bracket 500 may couple with a coupling member (e.g., a strut, beam, frame, or the like).

The adapter bracket 500 may include one or more mounting features 510. The mounting features 510 may facilitate coupling the adapter bracket 500 with other components of the support system 100. For instance, the adapter bracket 500 may include one or more studs 520. The studs 520 may receive a coupling member (e.g., a fastener, a threaded rod, or the like). For example, the studs 520 may threadingly engage with the coupling member. The studs 520 may be aligned with the mounting hole 170, for instance to facilitate coupling the adapter bracket 500 with the support portion 120 of the support system 100 (shown in FIG. 1).

The mounting features 510 may include one or more through holes 530. The through holes 530 may facilitate coupling structures to the support system 100. For instance, the adapter bracket 500 may include a first flange 540 and a second flange 550. The through holes 530 may extend through the flanges 540, 550. In an example, a coupling member may be secured between the flanges 540, 550. For instance, a bolt may be inserted into the through holes 530 in the flanges 540, 550 and the bolt (and a nut) may facilitate securing the coupling member to the adapter bracket 500. The through holes 530 may receive a securing member (e.g., a wire, clamp, fastener, or the like).

FIG. 6 illustrates a perspective view of the support system 100 including the adapter bracket 500 of FIG. 5. A coupling member 600 (e.g., a strut, beam, frame, or the like) may be attached to the support system 100. For example, the coupling member 600 may be received in the support channels 140, 150. The coupling member 600 may be located between the flanges 540, 550 of the adapter bracket 500. For example, the adapter bracket 500 may be coupled with the support portion 120. One or more fasteners 610 may engage with the bracket 500 and the coupling member 600, for instance to attach the coupling member 600 to the support system 100. The adapter bracket 500 may facilitate attaching the coupling member 600 in a vertical orientation, for instance projecting from the support portion 120 of the support system 100.

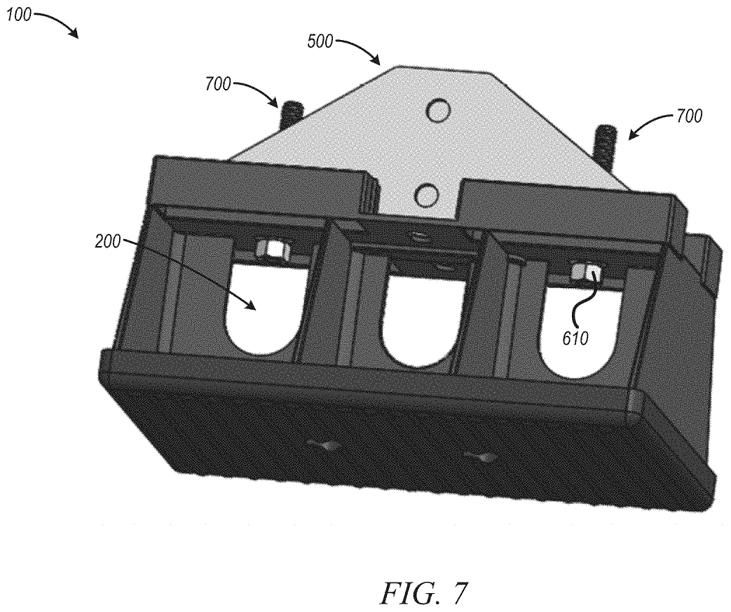

FIG. 7 illustrates another perspective view of the support system 100 including the adapter bracket 500 of FIG. 5. In an example, one or more threaded rods 700 may be coupled with the support system 100. For instance, the threaded rods 700 may be coupled with the studs 520 (shown in FIG. 5). The threaded rods 700 may extend through the mounting holes 170 of the supporting portion 120 (shown in FIG. 1). The fasteners 610 may secure the threaded rods 700 to the support system 100. For instance, the fasteners 610 may inhibit relative motion between the threaded rods 700 and the studs 520 of the adapter plate 500. The threaded rods 500 may project from the support portion 120 of the support system 100. The cutouts 200 may facilitate access to the threaded rods 700 and the fasteners 610.

The coupling member 600 may be attached to the threaded rods 700, for example to allow for height-adjustment of a structure supported by the support system 100. For instance, the coupling member 600 may span between the threaded rods 700. The threaded rods 700 may extend through the coupling member 600. One or more fasteners (e.g., a nut, or the like) may secure the coupling member 600 to the threaded rods 700. The coupling member 60( )may support the structure.

In some examples, a plurality of the support system 100 are used to a structure. For instance, a first support system (e.g., a first base portion 110 coupled with a first supporting portion 120) may support a first section of the structure. A second support system 100 a second base portion 110 coupled with a second supporting portion 120) may support a second section of the structure. In an example, the plurality of the support system 100 may support a frame (e.g., a structural skeleton, or the like), and the structure may be coupled to the frame. The frame may include one or more of the coupling member 145 (or the coupling member 160). Accordingly, the plurality of the support system 100 may cooperate to support the structure. The support system 100 may enhance flexibility in mounting structures so that a number of mounts and mounting positions are available, especially for the mounting (and support) of more than one structure.

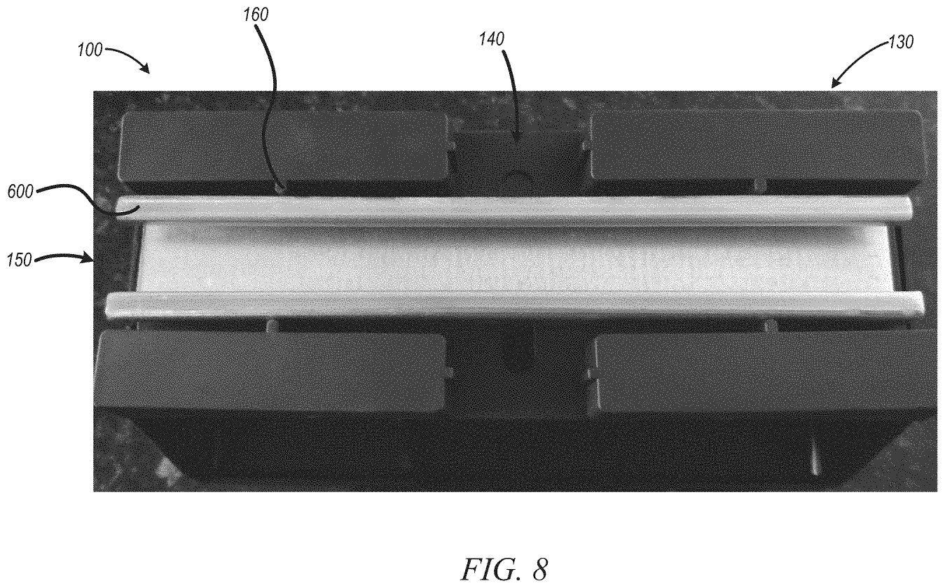

FIG. 8 illustrates a top view of the support system 100. As described herein, the support channels 140, 150 may receive a structure. The support channels 140, 150 may receive the coupling member 600. The interference ridges 160 may extend into the support channels 140, 150. For instance, the ridge 160 may facilitate holding the coupling member 600 (or a structure) within the channels 140, 150. The interference ridge 160 may provide an interference fit between the guides 130 and the coupling member 600. Accordingly, the interference ridge 160 may enhance retention of the coupling member 600 within the support channels 140, 150.

### EXAMPLES

Example 1 is a support system for separating a structure from a roof of a building, comprising: a base portion including a composite material, wherein the base portion includes at least one rounded edge configured to reduce the engagement of the base portion with the structure; a support portion coupled to the base portion and including the composite material; at least one support channel sized and shaped to receive the structure and straddle the structure when the structure is received in the support channel; and wherein the base portion defines at least one cutout configured to reduce the amount of drag on the support system when the support system is exposed to wind.

In Example 2, the subject matter of Example 1 optionally includes wherein the at least one support channel includes a first support channel and a second support channel.

In Example 3, the subject matter of Example 2 optionally includes wherein the first support channel intersects the second support channel,

In Example 4, the subject matter of any one or more of Examples 2-3 optionally include wherein the first support channel is isolated from the second support channel.

In Example 5, the subject matter of any one or more of Examples 1-4 optionally include one or more guides extending from a support surface of the support portion, wherein the one or more guides define a portion of the support channel.

In Example 6, the subject matter of Example 5 optionally includes wherein the one or more guides includes: a first guide located on a first side of the support channel; a first interference ridge projecting from the first guide, wherein the first interference ridge extends into the support channel from the first guide; and the first interference ridge is configured to engage with the structure and enhance retention of the structure within the support channel.

In Example 7, the subject matter of Example 6 optionally includes wherein the one or more guides includes: a second guide located on a second side of the support channel; a second interference ridge projecting from the second guide, wherein the second interference ridge extends into the support channel from the second guide; and the second interference ridge is configured to engage with the structure and enhance retention of the structure within the support channel.

In Example 8, the subject matter of any one or more of Examples 5-7 optionally include wherein the one or more guides includes a low durometer material.

In Example 9, the subject matter of any one or more of Examples 1-8 optionally include a boot attachable to the base portion and configured to enhance friction between the roof of the building and the support system.

Example 10 is a support system for separating a structure from a roof of a building, comprising: a base portion including a composite material, wherein the base portion includes at least one rounded edge configured to reduce the engagement of the base portion with the structure; a support portion coupled to the base portion and including the composite material; at least one support channel sized and shaped to receive one or more of the structure or a coupling member and straddle the structure or the coupling member when the structure is received in the support channel; and wherein the base portion defines at least one cutout configured to reduce the amount of drag on the support system when the support system is exposed to wind.

In Example 11, the subject matter of Example 10 optionally includes an adapter bracket received in the support channel, wherein the adapter bracket includes one or more mounting features configured to receive a fastener and facilitate coupling the structure with the support system.

In Example 12, the subject matter of any one or more of Examples 1-11 optionally include the coupling member received in the support channel.

In Example 13, the subject matter of any one or more of Examples 10-12 optionally include wherein the at least one support channel includes a first support channel and a second support channel.

In Example 14, the subject matter of Example 13 optionally includes wherein the first support channel intersects the second support channel.

In Example 15, the subject matter of any one or more of Examples 13-14 optionally include wherein the first support channel is isolated from the second support channel.

In Example 16, the subject matter of any one or more of Examples 10-15 optionally include one or more guides extending from a support surface of the support portion, wherein the one or more guides define a portion of the support channel.

In Example 17, the subject matter of Example 16 optionally includes wherein the one or more guides includes: a first guide located on a first side of the support channel; a first interference ridge projecting from the first guide, wherein the first interference ridge extends into the support channel from the first guide; and the first interference ridge is configured to engage with the structure and enhance retention of the structure within the support channel.

In Example 18, the subject matter of Example 17 optionally includes wherein the one or more guides includes: a second guide located on a second side of the support channel; a second interference ridge projecting from the second guide, wherein the second interference ridge extends into the support channel from the second guide; and the second interference ridge is configured to engage with the structure and enhance retention of the structure within the support channel.

In Example 19, the subject matter of any one or more of Examples 16-18 optionally include wherein the one or more guides includes a low durometer material.

In Example 20, the subject matter of any one or more of Examples 1-19 optionally include a boot attachable to the base portion and configured to enhance friction between the roof of the building and the support system.

This detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the inventors also contemplate examples in which only those elements shown or described are provided.

In this document, the terms “a” or “an” are used, as is common in patent documents, to include one or more than one, independent of any other instances or usages of “at least one” or “one or more.” in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description.

What is claimed is:

1. A support system for separating a structure from a roof of a building, comprising:
a base portion including a composite material, wherein the base portion includes at least one rounded edge configured to reduce the engagement of the base portion with the structure;
a support portion coupled to the base portion and including the composite material;
at least one support channel sized and shaped to receive the structure and straddle the structure when the structure is received in the support channel; and
wherein the base portion defines at least one cutout configured to reduce the amount of drag on the support system when the support system is exposed to wind.

2. The support system of claim 1, wherein the at least one support channel includes a first support channel and a second support channel.

3. The support system of claim 2, wherein the first support channel intersects the second support channel.

4. The support system of claim 2, wherein the first support channel is isolated from the second support channel.

5. The support system of claim 1, further comprising one or more guides extending from a support surface of the support portion, wherein the one or more guides define a portion of the support channel.

6. The support system of claim 5, wherein the one or more guides includes:
a first guide located on a first side of the support channel;
a first interference ridge projecting from the first guide, wherein the first interference ridge extends into the support channel from the first guide; and
the first interference ridge is configured to engage with the structure and enhance retention of the structure within the support channel.

7. The support system of claim 6, wherein the one or more guides includes:
a second guide located on a second side of the support channel;
a second interference ridge projecting from the second guide, wherein the second interference ridge extends into the support channel from the second guide; and
the second interference ridge is configured to engage with the structure and enhance retention of the structure within the support channel.

8. The support system of claim 5, wherein the one or more guides includes a low durometer material.

9. The support system of claim 1, further comprising a boot attachable to the base portion and configured to enhance friction between the roof of the building and the support system.

10. A support system for separating a structure from a roof of a building, comprising:
a base portion including a composite material, wherein the base portion includes at least one rounded edge configured to reduce the engagement of the base portion with the structure;
a support portion coupled to the base portion and including the composite material;
at least one support channel sized and shaped to receive one or more of the structure or a coupling member and straddle the structure or the coupling member when the structure is received in the support channel; and
wherein the base portion defines at least one cutout configured to reduce the amount of drag on the support system when the support system is exposed to wind.

11. The support system of claim 10, further comprising an adapter bracket received in the support channel, wherein the adapter bracket includes one or more mounting features configured to receive a fastener and facilitate coupling the structure with the support system.

12. The support system of claim 1, further comprising the coupling member received in the support channel.

13. The support system of claim 10, wherein the at least one support channel includes a first support channel and a second support channel.

14. The support system of claim 13, wherein the first support channel intersects the second support channel.

15. The support system of claim 13, wherein the first support channel is isolated from the second support channel.

16. The support system of claim 10, further comprising one or more guides extending from a support surface of the support portion, wherein the one or more guides define a portion of the support channel.

17. The support system of claim 16, wherein the one or more guides includes:
a first guide located on a first side of the support channel;
a first interference ridge projecting from the first guide, wherein the first interference ridge extends into the support channel from the first guide; and
the first interference ridge is configured to engage with the structure and enhance retention of the structure within the support channel.

18. The support system of claim 17, wherein the one or more guides includes:
a second guide located on a second side of the support channel;
a second interference ridge projecting from the second guide, wherein the second interference ridge extends into the support channel from the second guide; and
the second interference ridge is configured to engage with the structure and enhance retention of the structure within the support channel.

19. The support system of claim 16, wherein the one or more guides includes a low durometer material.

20. The support system of claim 1, further comprising a boot attachable to the base portion and configured to enhance friction between the roof of the building and the support system.
